(19) United States
(12) Patent Application Publication
(10) Pub. No.: US 2012/0233220 A1
(43) Pub. Date: Sep. 13, 2012

(54) Controlling Access To A Computer System

(76) Inventors: Albert Kaschenvsky, Yehud (IL); Michael Elman, Yehud (IL); Asaf Barkan, Yehud (IL); Oded Zilinsky, Yehud (IL)

(21) Appl. No.: 13/042,649

(22) Filed: Mar. 8, 2011

(51) Int. Cl. G06F 17/30

(52) U.S. Cl. 707/803; 707/E17.005

(57) ABSTRACT

A technique including accessing data to control permissions assigned to a given role for a computer system. The data assigns the given role with a role template and an environment template, wherein the role template defines at least one action that can be performed with the system, the environment template defines at least one resource of the system that can be accessed, and the role and environment templates are independently assignable to at least one other role. The technique includes controlling access to the system based on the data.

### TECHNICAL FIELD OF THE INVENTION

The invention generally relates to controlling access to a computer system.

### BACKGROUND

User access to an information technology (IT) system typically is controlled through the use of security policies. The security policies control access to actions that may be performed by users of the IT system, as well as control which resources of the system may be accessed by the users. Some actions may not be related to any specific resource of the IT system, such as actions that involve running optimization tasks or running antivirus software. Some actions may, however, involve accessing some specific resources of the IT system, such as specific files, databases and mail accounts.

### BRIEF DESCRIPTION OF THE DRAWING

FIG. 1 is a schematic diagram of a processing system according to an example implementation.

FIGS. 2 and 4 are flow diagrams of techniques to control access to a computer system based on role-based permissions according to example implementations.

FIG. 3 is an illustration of role-based permission assignments according to an example implementation.

### DETAILED DESCRIPTION

One way to control and manage access to a business organization's information technology (IT) system (i.e., a computer system) is through role-based access control (RBAC). In RBAC, each user is assigned a role, and the role represents a set of permissions, which controls the operations that the user may perform and the system resources that the user may access.

Users may frequently change their departments and roles in the business organization. Consequently, IT administrators typically frequently change the users' permissions to accommodate these changes. In theory, the RBAC assignments allow partitioning of access management between the different groups such as the human resources (HR) group, IT groups and other groups of the organization. The HR group typically performs the task of assigning users to given roles, and each user inherits the permissions that are assigned to that role automatically. Although the IT administrators may define and change the actual permissions that are provided by a given role, the role is supposed to remain relatively stable.

It is not uncommon, however, for personnel that perform similar tasks, such as database administrators (as a non-limiting example), to have different permissions in different departments. For example, the database administrator of department A may have permissions to manage databases and have access to other resources in department A; and the database administrator of department B may have similar permissions on resources belonging to department B. Due to this scenario, a specific set of permissions may be assigned to each one of the roles, which means, under the RBAC scheme, different roles may be created for the department A and department B database administrators. Consequently, the similarities between the database administrator roles may be lost and therefore not expressed in the management of security policies. As a result, the use of RBAC in an organization that has a relatively large number of resources may produce a considerably long access control list (ACL) for purposes of managing the security policies of the organization.

Systems and techniques are disclosed herein for purposes of limiting the expansion of permissions to accommodate the above-described similarities of roles, while adhering to classical RBAC roles. The role access control that is disclosed herein assigns the same sets of permissions to users who are assigned to exactly the same sets of roles while allowing flexibility for associating a user with a particular role, a particular set of actions and a given environment.

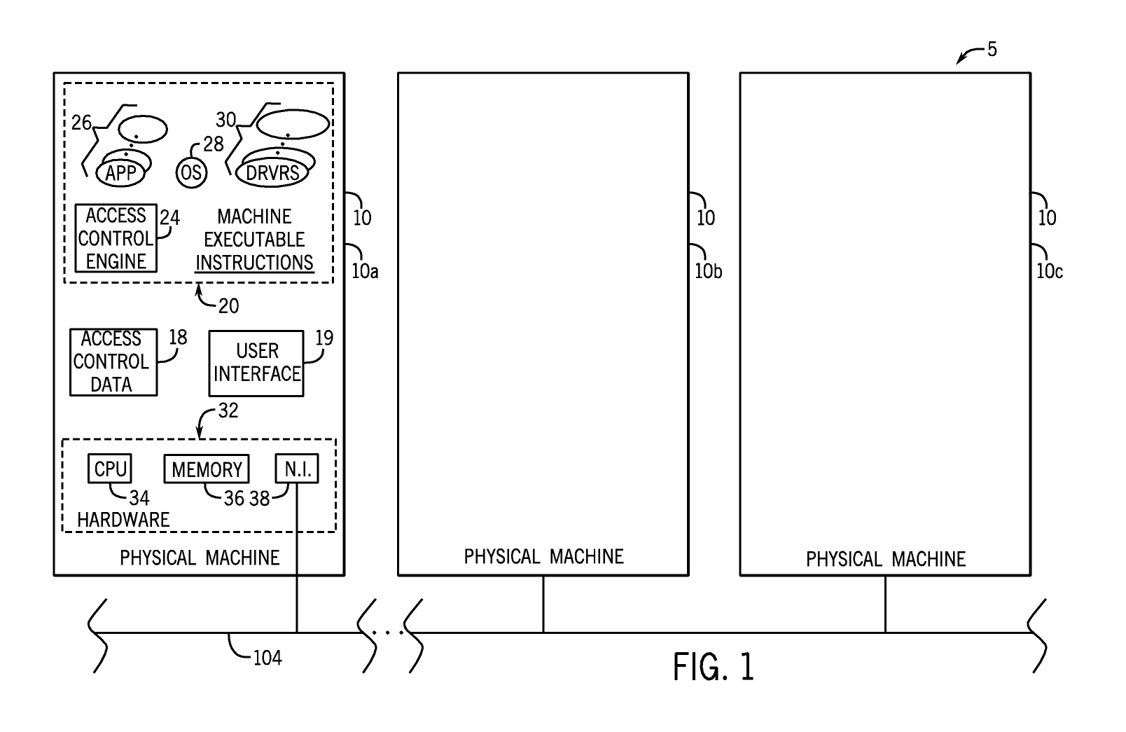

Referring to FIG. 1, as a non-limiting example, the systems and techniques that are disclosed herein may be implemented on an organization's information technology (IT) system, which is a computer system 5 that includes one or multiple physical machines 10 (physical machines 10a, 10b and 10c, being depicted in FIG. 1, as specific examples). In this context, a “physical machine” indicates that the machine is an actual machine made up of executable program instructions and hardware. Examples of physical machines include computers (e.g., application servers, storage servers, web servers, etc.), communications modules (e.g., switches, routers, etc.) and other types of machines. The physical machines 10 may be located within one cabinet (or rack); or alternatively, the physical machines 10 may be located in multiple cabinets (or racks).

As shown in FIG. 1, the physical machines 10 may be interconnected by network connection fabric 104, such as a network connection fabric that establishes connections for a local area network (LAN), a wide area network (WAN), the Internet, or any other type of communications link. The network fabric 104 may also include system buses or other fast interconnects.

In accordance with a specific non-limiting example that is described herein, one of the physical machines 10a contains machine executable instructions 20 and hardware 32, which control and manage access to IT resources of the computer system 5 and, in general, control user access to performing actions on the systems. Dependent on the particular implementation, the physical machine 10a may be a server and/or a client. For example, the physical machine 10a may control access to IT resources for users of the physical machine 10a and/or users of one or multiple physical machines 10 of the network 5. The physical machine 10a may represent part of the protected IT resources; and moreover, the protected resources may be present on one or more of the physical machines 10, such as physical machines 10b and/or 10c, as a non-limiting example. Thus, many variations are contemplated and are within the scope of the appended claims.

The architecture that is depicted in FIG. 1 may be implemented in an application server, a storage server farm (or storage area network), a web server farm, a switch or router farm, other type of data center, and so forth. Also, although three physical machines 10a, 10b and 10c are depicted in FIG. 1, it is noted that more than three physical machines 10 or fewer than three physical machines 10 may be used, in accordance with other implementations. Additionally, although each of the physical machines 10 is depicted in FIG. 1 as being contained within a box, it is noted that a given physical machine 10 may be a distributed machine having multiple nodes, which provide a distributed and parallel processing system.

As depicted in FIG. 1, in some implementations, the machine executable instructions 20 may include one or multiple applications 26, an operating system 28 and one or multiple device drivers 30 (which may be part of the operating system 28). In general, the machine executable instructions 20 are stored in a non-transitory storage medium or in multiple non-transitory storage media, such as (as non-limiting examples) in a memory (such as a memory 36) of the physical machine 10a, in removable storage media, in optical storage, in semiconductor storage, in magnetic storage, in non-removable storage media, in storage that is separate (local or remote) from the physical machine 10a, etc., depending on the particular implementation.

The hardware 32 may include a processor, such as one or multiple central processing unit (CPUs) 34 (one CPU 34 being depicted in FIG. 1 for purposes of a non-limiting example) and/or one or multiple CPU processing cores. The hardware 32 may also include the system memory 36 and a network interface 38. In some implementations, one or multiple processing cores may execute the machine executable instructions 20.

In general, the physical machine 10a, for this example, includes a specific set of machine executable instructions, called an access control engine 24, which when executed by the physical machine 10a, cause the physical machine 10a to 1.) display a user interface 19 to allow an administrator to store access control data 18 to assign users to roles and assign permissions to the roles, as described herein; and 2.) control access of the users to actions on the computer system 5 and resources of the system 5 based on the access control data 18. As described herein, the access control engine 24 allows the assignment of the permissions based on roles, role templates and environment.

In general, an “action” is an operation that a user tries to perform in the computer system 5. As a non-exhaustive and exemplary list, these actions may be actions to execute scripts, delete logs, create reports, edit files, view system status, perform backups, create tables, delete tables, create schema, delete schema, create reports, edit reports, delete reports, install a database and uninstall a database.

Actions may be performed on some modeled resources of the computer system 5, such as on files or database tables. However, actions may be performed on resources that are not associated with any particular modeled resource. For example, a “delete” action may be connected to some file, table or table entry that is to be deleted. Moreover, actions such as actions to view system status or perform a backup may not be associated with a modeled resource but still may describe an operation that the user may or may not be authorized to perform.

The “role template” refers to a group of actions. In this regard, the role template describes a set of tasks, or actions, that the user may perform as part of the user's job, but the role template does not specific the specific IT resources to be accessed for these actions. For example, a database administrator may be a role in the computer system 5, which may have certain administrator permissions to access certain database instances, special management software and knowledge bases. However, the database administrator role does not define what specific resources, such as the specific data instances or hosts, which the user accesses to perform its authorized role.

It is noted that, as a non-limiting example, all enterprise database administrators may be assigned to exactly the same role template. In this manner, this role template may define which set of permitted actions that are to be performed by all database administrators, in general, such as actions to create tables, delete tables, update tables, create schema, delete schema, install databases on hosts, uninstall databases, create reports, perform backups, etc.

The “environment” represents the group of resource instances, which may be accessed. Therefore, the triplet (role, role template, environment) defines the real permissions of a given role and defines what actions the associated user is authorized to perform and the resources the user is permitted to access in the computer system 5. A given environment may be defined merely by listing the specific resource instances, like database one, database two, database three, personal computer one, personal computer two, etc. Alternatively, a given environment may be defined by more general statements, such as, “all resources within Internet protocol (IP) addresses 10-20,” or, “all resources belonging to department A.”

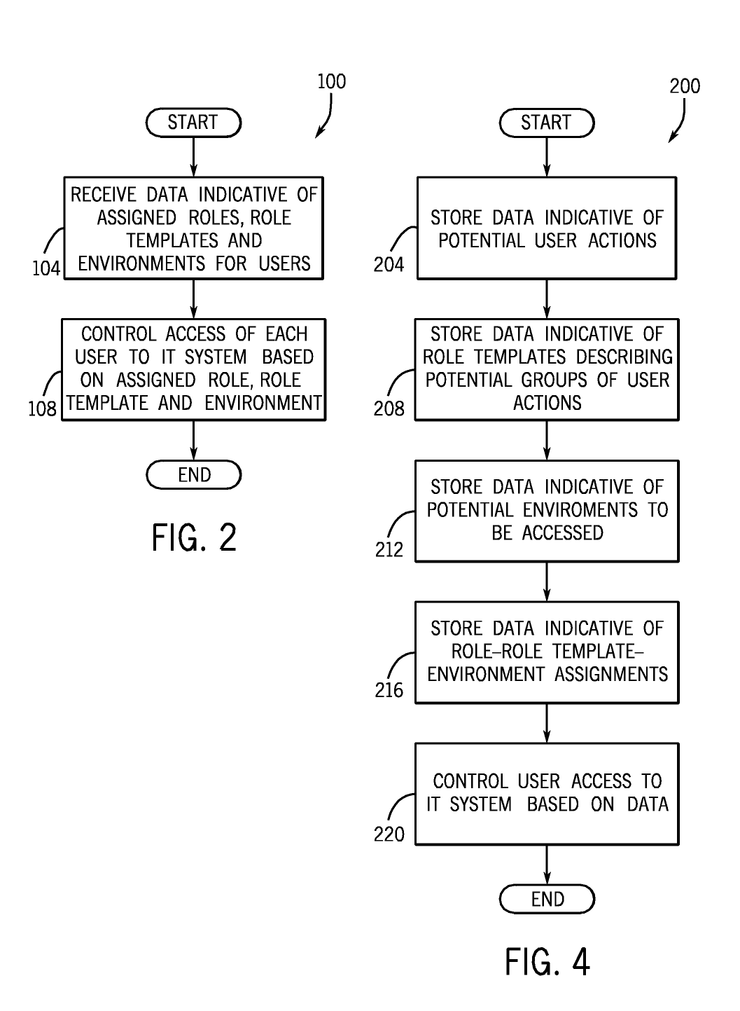

Referring to FIG. 2 in conjunction with FIG. 1, thus, in accordance with embodiments of the invention, the access control engine 24 (FIG. 1) may cause the physical machine 10a to perform a technique 100 for purposes of controlling and managing security policies in connection with the computer system 5. Pursuant to the technique 100, the physical machine 10a accesses data (block 104), which is indicative of assigned roles, role templates and environments for users of the computer system 5. This data may be created through an authorized user interface that permits an authorized administer to manipulate the data to indicate assignments of users to roles and the specific (role, role template, environment template) triplets. The physical machine 10a controls access (block 108) of each user to the IT system based on the assigned role, role template and environment.

It is noted that the techniques that are described herein, in accordance with some implementations, do not change the function of the role (compared to the RBAC), as the role eventually corresponds to a set of permissions. However, techniques that are described herein allow the independent associating of the role templates and environments to the roles to permit the management of the permissions that are assigned to the roles in a clear and scalable manner.

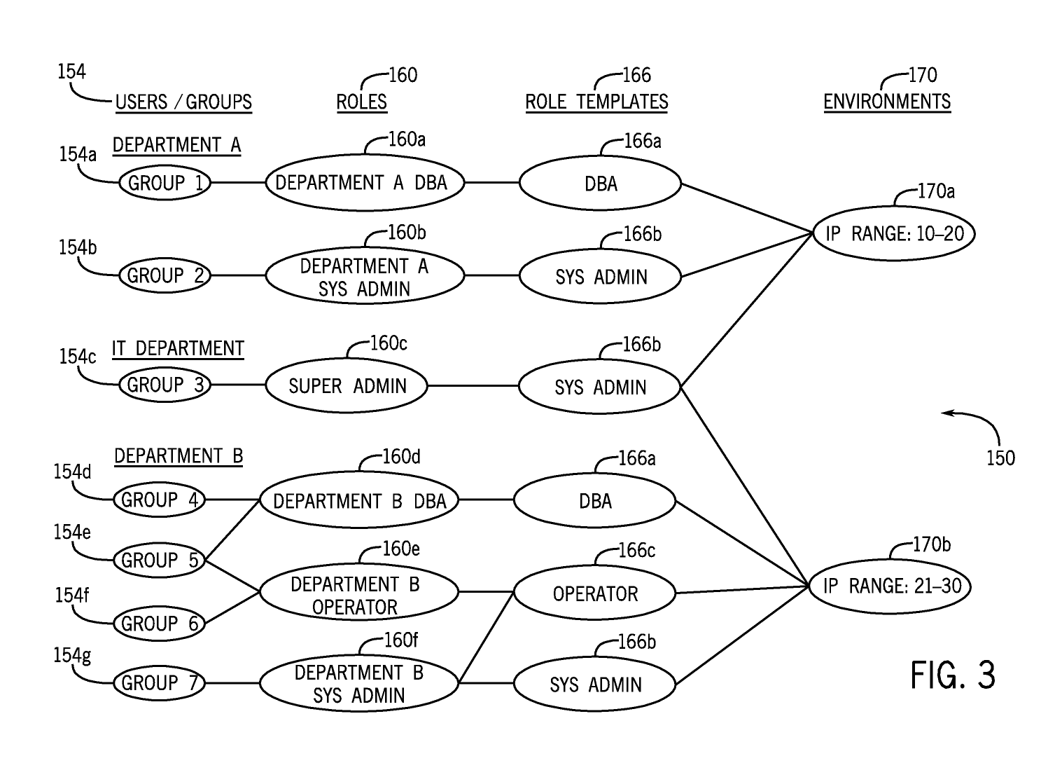

As a more specific example, FIG. 3 depicts an illustration of the management and control of the security policies of the computer system 5. For this example, the organization has three departments, labeled, “department A,” “IT department,” and “department B.” Moreover, the organization for this example has database administrators, system administrators, operators and a supervisory administrator. These roles may not be modeled as classical RBAC roles, because, for example, the database administrator of department A has different permissions from the database administrator of department B. As shown in FIG. 3, six roles 160 are created: department A database administrator 160a, department A system administrator 160b, supervisory administrator 160c, department B database administrator 160d, department B operator 160e and department B system administrator 160f.

As illustrated in FIG. 3, users of the organization who are assigned to the roles 160 may be divided in seven groups 154 of users: groups 154a and 154b in department A; group 154c in the IT department; and groups 154d, 154e, 154f and 154g of department B.

The techniques that are described herein permit a more scalable approach for assigning permissions for the user groups 154a-154g instead of directly defining the permission for each role. More specifically, as illustrated in FIG. 3, three role templates 166 are defined: a database administrator role template 166a, a system administrator role template 166b and an operator role template 166c. Moreover, as illustrated in FIG. 3, the users access resources in one of two environments 170: a first environment 170a in the IP address range of 10 to 20; and an environment 170b in the IP address range of 21-30. As can be seen from FIG. 3, all hosts and databases of department A have IP addresses in the range of 10-20, and all hosts in databases in department B have IP addresses in the range of 21-30.

Given the assignments that are depicted in FIG. 3 and defined by the access control data 18 (see FIG. 1), the physical machine 10a under the access control engine 24 (see FIG. 1) deduces that the users of group 154f are assigned to the department B operator role 160d; and these users may perform an operator duty (as defined by role template 166c) on all equipment in the IP addresses 21-30. As another specific example, the users of group 154g are department B system administrators, as defined by role 160f, and these users may perform operator and system administrator tasks (defined by role templates 166c and 166b) on all equipment in the IP address range of 21-30. In other words, these users may perform tasks on all equipment belonging to department B.

Referring to FIG. 1 in conjunction with FIG. 4, thus, in accordance with embodiments of the invention, the physical machine 10a when executing the access control engine 24, may perform a technique 200 that includes storing (block 204) data indicative of potential user actions and storing (block 208) data indicative of role templates, which describe potential groups of user actions. Pursuant to the technique 200, the physical machine 10a further stores (block 212) data indicative of potential environments to be accessed and stores (block 216) data indicative of role-role template-environment assignments. Based on this stored data, the physical machine 10a controls (block 220) user access to the computer system 5.

Other variations are contemplated and are within the scope of the appended claims. For example, in accordance with other implementations, role template hierarchy and environment hierarchy may be used for purposes of further improving the scalability. As a non-limiting example, actions that are includes in the system administrator role template may include actions in the operator role template. Thus, many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
accessing data to control permissions assigned to a given role for a computer system, the data assigning the given role with a role template and an environment template, wherein the role template defines at least one action that can be performed with the system, the environment template defines at least one resource of the system that can be accessed, and the role and environment templates are independently assignable to at least one other role; and
using a processor-based machine to control access to the system based on the data.

2. The method of claim 1, wherein the data further assigns a given user of a plurality of users of the system to the role, and the controlling comprises controlling permissions assigned to the given user.

3. The method of claim 2, wherein at least one of the other users is assigned to the given role.

4. The method of claim 1, wherein the data assigns the role template to at least one other role.

5. The method of claim 1, wherein the data assigns the environment template to at least one other role.

6. The method of claim 1, wherein said at least one action comprises an action selected from the following: executing a script, deleting a log, creating a report, editing a file, viewing a system status, performing a backup, creating schema, and deleting schema.

7. The method of claim 1, wherein said at least one resource comprises a resource selected from the following: a resource associated with an Internet Protocol (IP) address range and a resource associated with a department of an organization associated with the system.

8. An apparatus comprising:
an access control engine adapted to provide display of a user interface to allow an administrator to store data to assign a given user to a given role and control permissions assigned to the given role, the interface to permit the administrator to assign the given role with a role template and an environment template, wherein the role template defines at least one action that can be performed on a computer system, the environment template defines at least one resource of the computer system that can be accessed, and the role and environment templates are independently assignable to at least one other role; and
a processor to control access of the given user to a computer system based on the data.

9. The apparatus of claim 8, wherein the user interface is further allows the administrator to assign at least one other user to the given role.

10. The apparatus of claim 8, wherein the apparatus comprises a server and the computer system comprises a client of the server.

11. The apparatus of claim 8, wherein the apparatus is part of the computer system.

12. The apparatus of claim 8, wherein said at least one action comprises an action selected from the following: executing a script, deleting a log, creating a report, editing a file, viewing a system status, performing a backup, creating schema and deleting schema.

13. The apparatus of claim 8, wherein said at least one resource comprises a resource selected from the following: a resource associated with an Internet Protocol (IP) address range and a resource associated with a department of an organization associated with the system.

14. An article comprising a computer readable storage medium to store instructions that when executed by a computer cause the computer to:
access data to control permissions assigned to a given role for a computer system, the data assigning the given role with a role template and an environment template, wherein the role template defines at least one action that can be performed with the system, the environment template defines at least one resource of the system that can be accessed, and the role and environment templates are independently assignable to at least one other role; and
control the access to the system based on the data.

15. The article of claim 14, wherein the data further assigns a given user of a plurality of users of the system to the role, and the controlling comprises controlling permissions assigned to the given user.

16. The article of claim 14, wherein at least one of the other users is assigned to the given role.

17. The article of claim 14, wherein the data assigns the role template to at least one other role.

18. The article of claim 14, wherein the data assigns the environment template to at least one other role.

19. The article of claim 14, wherein said at least one action comprises an action selected from the following: executing a script, deleting a log, creating a report, editing a file, viewing a system status, performing a backup, creating schema and deleting schema.

20. The article of claim 14, wherein said at least one resource comprises a resource selected from the following: a resource associated with an Internet Protocol (IP) address range and a resource associated with a department of an organization associated with the system.
